(19) United States
(12) Patent Application Publication
(10) Pub. No.: US 2002/0169622 A1
(43) Pub. Date: Nov. 14, 2002

(54) Process for enhancing development of real estate

(76) Inventor: Paul Estridge JR., Carmel, IN (US)

Correspondence Address: KRIEG DeVAULT ALEXANDER & CAPEHART, LLP, 825 Anthony Wayne Building, 203 E. Berry Street, Fort Wayne, IN, 46802, US

(21) Appl. No.: 09/850,993

(22) Filed: May 9, 2001

(51) Int. Cl. G06F 17/60

(52) U.S. Cl. 705/1

(57) ABSTRACT

A new and improved process for the development of real estate comprising the steps of separating private easements for the provision of common services in a developed community from the dedicated public right-of-way; establishing decision making authority regarding control over these private easements in a single privately owned entity to identify and contract with various service providers; precluding access to these privately owned easements by governmental franchisees for providing the common services; and providing the common services to the developed community from a single source which obtains the particular services from one or more other service providers, in order to reduce the number of service media and points of access required for the services.

### BACKGROUND OF THE INVENTION

The present invention pertains to a process for managing rights and interests in real estate and more particularly to a new and improved process for the establishment, preservation, exploitation, and use of private real estate easements for providing access to a developed residential or commercial business community to common communication, utility, and entertainment services providers; to a new and improved process for providing ownership and control over private common services easements in real estate; to a new and improved process for providing common services to associated real estate owners; and more particularly to a new and improved process for limiting the rights of governmental entities having beneficial control over public easements for common services.

In a typical development of a residential or commercial business community, the process, from purchase of the initial parcel of real estate to the sale of lots within the parcel to building upon the lots, is generally the same. First, a developer identifies a development opportunity and may form a local development entity in order to purchase the particular parcel of real property. The developer then, alone or through the development entity, designs the community, such as a residential subdivision, a business park, or industrial park, by creating drawings, plats and plans for the community. The developer next establishes and obtains approval from the local municipality or other appropriate governmental entity for general declarations, covenants, and restrictions for the community that subsequently run with the real estate through the chain of title. The developer then files and records these declarations, covenants, restrictions, plats and plans with a property title recorder, such as a local county recorder's office. The plat or plan typically contains a dedication of roadways, curbs, sidewalks, utility, and other service easements and public rights-of-way to the local municipality or other governmental entity. In the event the real estate is not located in a municipality, the dedication contained on the plat or plan is made effective upon annexation of the real estate into a municipality. Traditionally, each dedication has included, although it has not expressly differentiated between, both surface and subsurface rights-of-way within the dedication. Usually, through such a dedication, the municipality provides, either directly or through operation of law, access to the public rights-of-way to certain service providers that have franchising arrangements with the municipality for the provision of water, sewer, natural gas, electricity, phone, cable and other common services. Through the municipality's right-of-way, the Federal Trade Communication (FTC) and the Federal Communications Commission (FCC) obtain jurisdiction over the public rights-of-way used for providing these common services. As a result, the laws, rules and regulations of the FTC and the FCC apply to the community's common services easements. Once the community is built out, neither the developer, the builder, the community, the homeowners, nor the homeowner's association have any control over the common services providers having access through public rights-of-way, except indirectly through the public's representatives in the municipality or other govermnental agency. As a result, the value of these common services easements through the public right-of-way is removed from each lot within the community often even before lot owners obtain title to their lots. It is therefore highly desirable to provide a new and improved method of preserving private control over easements for common services access to real estate. It is also highly desirable to provide a new and improved method of providing common services to real estate owners. It is also highly desirable to provide a new and improved method for establishing beneficial and private ownership and control over common services easements and the access to developed communities by common services providers.

The need for a new approach to developing a community has become particularly evident since the passage of the Telecommunications Act of 1996, under which regulation of the provision of common services has decreased in certain respects. With regard to common telecommunications and cable services, the federal deregulation scheme currently being implemented increases the role of state and/or local regulation as a result of decreased federal control, and encourages departure from the typical development process. Such deregulation is intended to give consumers greater control in choosing individual service providers. It is therefore also highly desirable to provide a new and improved method by which private rights to common services easements are established by separating the common services easements from the public rights-of-way which are dedicated for roadways, curbs and sidewalks to a municipality, and by which the dedicated public rights-of-way are taken subject to these private rights. However, because the FTC and FCC continue to have jurisdiction over telecommunication service providers through municipal rights-of-way, and because municipal franchisees obtain access to such developed communities through the dedication of rights to the municipality, it is difficult to avoid the access, use, and/or exploitation of common services easements within the developed community by the municipality or its common services franchisees in a way that makes competition for telecommunication services within the developed community worth the time, effort, and investment of independent common services providers. It is therefore highly desirable to provide a new and improved method by which a complete bundle of common services easements is segregated from the public rights-of-way dedicated to the municipality, and is held by a private access entity over which the municipality, FTC and FCC have no jurisdiction.

Telecommunication services are generally provided by an individual provider for each type of telecommunication services. Thus, generally there is an individual provider for each of phone services, cable services, internet services, and video-on-demand services for a single subscriber, such as a homeowner. Due to federal deregulation, more than one provider of a particular service may have access to provide such services in a particular geographic area. However, unless each provider is permitted or otherwise entitled to access a common medium for providing the particular service, such as a phone line or cable, each provider will use its own separate service media, which will require additional points of access to the subscriber of the service for providing the particular service. Even if a common medium is available for use by more than one provider, the ability of such a medium to handle multiple providers is physically limited. Especially in geographic areas where municipal franchisees have access to provide such common services through public rights-of-way, the availability of access to a community or to a particular home or business becomes diminished, the service medium cluttered, and the speed of services over the medium generally slowed down. As a result, it would be beneficial to be able to provide several of the common services through a single provider, especially if this single provider can provide several of the common services through a single service medium, thereby decreasing the number of points of access to each subscriber required. It is therefore also highly desirable to provide anew and improved method whereby common services easements are separated from the public rights-of-way to be dedicated to a municipality or other governmental entity and held by a private access entity for licensing common services access rights to several providers or to a single provider to provide the common services to the developed community in the best way possible.

The traditional development approach described above represents longstanding practice in real estate development. This practice has become a tradition that mirrors decades of public policy supporting the existence of only one company for each of phone, cable, electric, natural gas, and water services within a municipality or other governmental entity and, as a result, within each community. Recognition of these natural monopolies by regulatory fiat was logically supported by rationalizing that the economic benefit of the municipality or governmental entity could best be served if the high cost of governmental support for the common services was amortized among all residents. In terms of property law, such recognition is manifested in the dedication of public rights-of-way which may be used by the incumbent provider of a particular monopoly common service under such provider's franchise common local exchange carrier status or other governmentally provided authority.

Given that this longstanding tradition has served the public well, developers have been reticent to change. Developers have failed to notice that the dynamic in public policy has shifted to warrant a modification of the stable tradition of applying, recording, and approving common services easements and rights-of-way. Needs are arising, in light of the new regulatory environment, that cannot be addressed and satisfied by traditional real estate development practice.

Three conditions have brought about the need for change. First, there has been a clear and unyielding movement in national public policy toward the deregulation of industries that have traditionally been deemed natural monopolies. Telecommunications and cable television services have advanced the farthest in this regard, under the leadership of the FCC. Of most recent consequence in terms of telecommunications was passage by the U.S. Congress of the Telecommunications Act of 1996, which encourages entry of local phone service competitors. The Federal Energy Regulatory Commission has also begun the policy debate concerning how to best deregulate the provision of both natural gas and electricity.

Second, advances in technology have dramatically reduced the cost of providing various of these common services. As a result, in combination with the ever-increasing deregulation of these services, a major barrier to competitive entry has begun to crumble. This has been most evident in the development of telecommunications technology. An industry that was once dominated by a single company, AT&T, now provides a vast landscape of competitive opportunity for tens of thousands of new businesses.

Third, the surprising yet exciting emergence of the Internet has occurred. The growing presence of useful e-commerce/shopping sites, interesting content, and widespread, easy access to information have propelled the Internet forward into what has become a global phenomenon that promises to forever alter the way we shop, learn, communicate, and transact business. The accelerating ‘pull’ of the Internet has given rise to another new industry: provision of high-speed broadband access services that take advantage of advanced Internet capabilities such as audio and video streaming. As a result, cable television companies offer high speed cable modem service, telephone companies offer DSL and ADSL, and satellite providers compete with their own broadband access services.

In combination, these three factors have created the need for the method described herein. Currently, the focus is on the most basic level of common services, because telephone and cable companies are no longer considered traditional monopolies. Technology and regulatory policy now permit any number of potential competitors to vie for the right to serve a particular real estate development within a municipality, anywhere in the country.

As a result, any undeveloped parcel of real estate has now taken on added value in the form of what the market would pay for the right of access to any such real estate for the purpose of providing certain of these common services, including high-speed broadband access. This added market value is a function of the highest amount a potential service provider would be willing to pay in order to serve a prospective community with their services.

With respect to a particular parcel, the value of these access rights are not unlike mineral rights. In exchange for the right to have access to a particular development in order to extract value, an interested party usually must pay a fee. Therefore, it is highly desirable to provide a unique method and arrangement structure to facilitate and exploit common services access rights. This approach is designed to support the national pro-competitive framework that has been rapidly evolving over the last decade, that will inevitably continue its momentum.

Therefore, it is also highly desirable to provide a new and improved process for enhancing the development of real estate by taking advantage of the current scheme of federal deregulation of common services providers in order to provide consumers with more choices for obtaining such services.

It is also highly desirable to provide a new and improved process for the development of real estate that separates private easements for the provision of common services in a developed community from the public right-of-way.

It is additionally highly desirable to provide a new and improved process for the development of real estate that establishes control over and access to private easements in a developed community for the provision of common services in one private decision making entity that identifies and contracts with several service providers.

It is additionally highly desirable to provide a new and improved process for the development of real estate that precludes access, use, and exploitation of the public right-of-way dedicated within a developed community by governmental franchisee service providers.

It is further highly desirable to provide a new and improved process for the development of real estate that allows for the management of telecommunication services to subscribers in a developed community by a single provider.

It is also highly desirable to provide a new and improved process for the development of real estate that anticipates and encourages the provision of telecommunication services to subscribers in a developed community in a way that does not clutter or slow down the telecommunication services medium and access points for individual subscribers.

It is also highly desirable to provide a new and improved process for the development of real estate in which a single provider of telecommunication services provides such services to a developed community through one medium or only a few media that require access points to each subscriber.

Finally, it is highly desirable to provide a new and improved process for the development of real estate having all of the above identified features.

### SUMMARY OF THE INVENTION

It is therefore an object of the invention to provide a new and improved process for enhancing the development of real estate.

It is also an object of the invention to provide a new and improved method of preserving private control over easements for common services access to real estate.

It is also an object of the invention to provide a new and improved method of providing common services to real estate owners.

It is also an object of the invention to provide a new and improved method for establishing beneficial and private ownership and control over common services easements and over access to developed communities by common services providers.

It is also an object of the invention to provide a new and improved method by which private rights to common services easements are established by separating the common services easements from the public rights-of-way which are dedicated for roadways, curbs and sidewalks to a municipality or governmental entity, and by which the dedicated public rights-of-way are taken subject to these private rights.

It is also an object of the invention to provide a new and improved method by which a complete bundle of common services easements is segregated from the public rights-of-way dedicated to the municipality, and is held by a private access entity over which the municipality, FTC and FCC have no jurisdiction.

It is also an object of the invention to provide a new and improved method whereby common services easements are separated from the public rights-of-way to be dedicated to a municipality or other governmental entity and held by a private access entity for licensing common services access rights to several providers or to a single provider to provide the common services to the developed community in the best way possible.

It is also an object of the invention to provide a new and improved method that provides a unique method and arrangement structure to facilitate and exploit common services access rights.

It is also an object of the invention to provide a new and improved process for enhancing the development of real estate by taking advantage of the current scheme of federal deregulation of common services providers in order to provide consumers with more choices for obtaining such services.

It is also an object of the invention to provide a new and improved process for the development of real estate that separates private easements for the provision of common services in a developed community from the public right-of-way.

It is also an object of the invention to provide a new and improved process for the development of real estate that establishes control over and access to private easements in a developed community for the provision of common services in one private decision making entity that identifies and contracts with several service providers.

It is also an object of the invention to provide a new and improved process for the development of real estate that precludes access, use, and exploitation of the public right-of-way dedicated within a developed community by governmental franchisee service providers.

It is also an object of the invention to provide a new and improved process for the development of real estate that allows for the provision or management of telecommunication services to subscribers in a developed community by a single service provider.

It is also an object of the invention to provide a new and improved process for the development of real estate that anticipates and encourages the provision or management of telecommunication services to subscribers in a developed community in a way that does not clutter or slow down the telecommunication services medium and access points for individual subscribers.

It is also an object of the invention to provide a new and improved process for the development of real estate in which a single provider of telecommunication services provides such services to a developed community through one medium or only a few media that require access points to each subscriber.

It is also an object of the invention to provide a new and improved process for the development of real estate having all of the above identified features.

In the broader aspects of the invention, there is provided a new and improved process for the development of real estate comprising the steps of separating private easements for the provision of common services in a developed community from the dedicated public right-of-way; establishing decision making authority regarding control over these private easements in a single privately owned entity to identify and contract with various service providers; precluding access to these privately owned easements by governmental franchisees for providing the common services; and providing the common services to the developed community from a single source which obtains the particular services from one or more other service providers, in order to reduce the number of service media and points of access required for the services.

### BRIEF DESCRIPTION OF THE DRAWINGS

The above mentioned and other features and objects of the invention and the manner of attaining them will become more apparent and the invention itself will be better understood by reference to the following description of an embodiment of the invention taken in conjunction with the accompanying drawings wherein:

FIG. 1 is a diagrammatic illustration of the new and improved development process for separating private easements for the provision of common services from the public right-of-way easements dedicated to the public;

FIG. 2 is a diagrammatic illustration of the entities and their respective relationships there between in the new and improved development process;

FIG. 3 is a flow diagram of the contractual relationships of the new and improved development process;

FIG. 4 diagrammatically illustrates the provision of common telecommunication and utility services to a developed community in the new and improved development process.

### DESCRIPTION OF A SPECIFIC EMBODIMENT

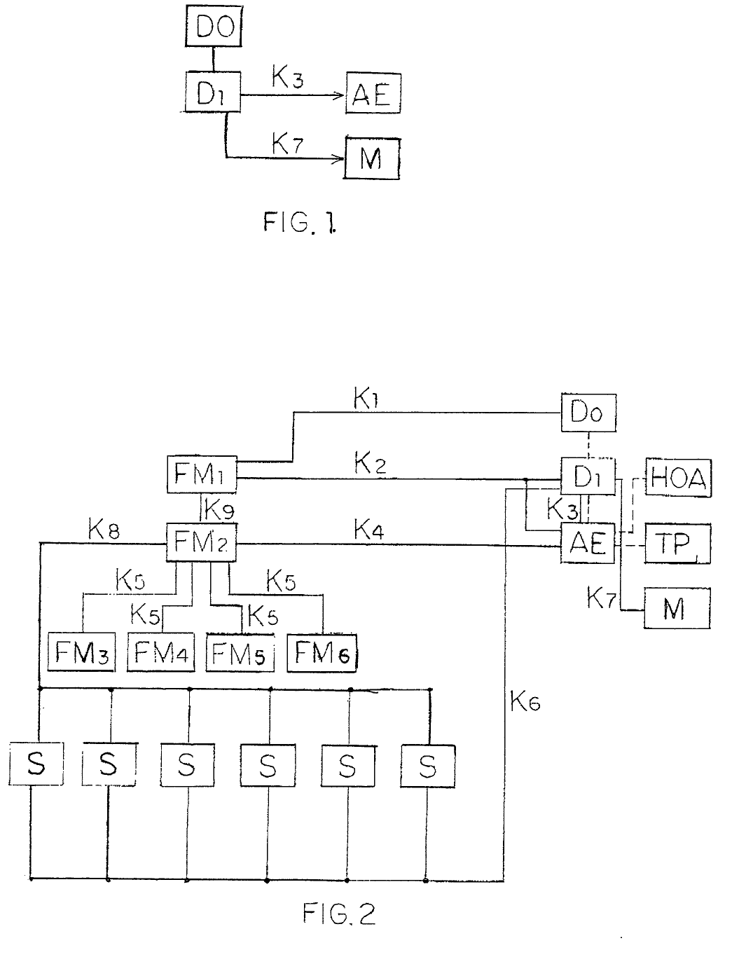

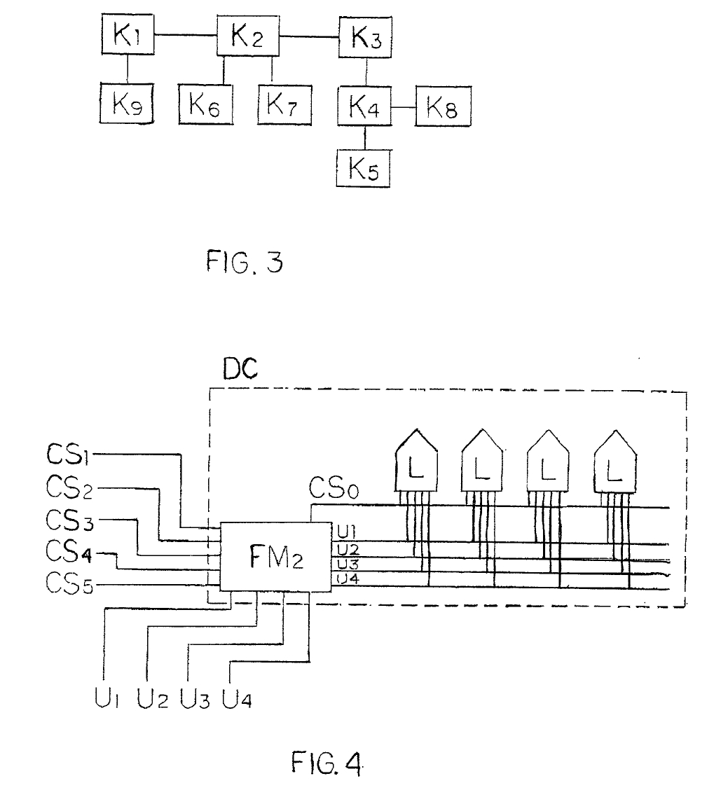

FIGS. 1 through 4 illustrate various aspects of the new and improved development process of the invention. FIG. 1 illustrates the relationship between the developer D0 and the municipality M and the access entity AE. FIG. 2 shows an overall organizational and relational flow diagram of the process for developing real property as a community. FIG. 3 illustrates the contractual relationships between the parties. FIG. 4 will be discussed further below. A developer D0 identifies and purchases a parcel of real estate for development as a residential, commercial, business, or mixed use community DC. In a specific embodiment, developer D0 forms a development entity D1 for purposes of acquiring fee simple ownership of the identified parcel. In another specific embodiment, the developer D0 or the development entity D1 may conduct a thorough examination, such as a title search, to discover any easements, reversions, and any other property rights to which fee simple in the real property of the parcel is subject, particularly in connection with telecommunication and other utility services access and proceeds in conventional ways to clear fee simple title in the parcel as required to accomplish the objects of the invention, prior to purchasing the parcel. In yet other specific embodiments, a development entity D1 verifies prior to purchase that such purchase will result in fee simple absolute in the real property.

The development entity D1 forms an access entity AE for the purpose of owning and managing private and exclusive easements over the parcel for purposes of providing common services to individual subscribers S. In a specific embodiment, the access entity AE is owned by the development entity D1. In other specific embodiments, the access entity AE is owned by an owner's association or a homeowner's association HOA formed for the developed residential community to be located on the parcel. In other specific embodiments, the access entity AE is owned by third parties TP not otherwise having connection with the development process. In yet other specific embodiments, the access entity AE is owned by any combination of the development entity D1, the homeowner's association HOA, and third parties TP. In all embodiments, the access entity AE is a legal or other organization such as a corporation, partnership, limited partnership, limited liability partnership, sole proprietorship, trust, real estate investment trust, limited liability company, or any recognizable entity capable of holding real estate.

Once the access entity AE is formed, the development entity D1 grants to the access entity a complete bundle of common services easements throughout the parcel of real property that permit the access entity AE to exclusively provide for delivery of common services to subscribers S located within the developed community DC. The common services, in a specific embodiment, include telecommunication services. In other specific embodiments, telecommunication services include cable services CS1, local and long distance telephone services CS3, internet/intranet services CS2, video-on-demand services CS4, and/or security monitoring services CS5. In yet other specific embodiments, the common services include certain deregulated utility services. Utility services, to the extent they are available on a deregulated basis, may include gas services U1, water services U2, sewer services U3, and/or electricity services U4. In yet another specific embodiment, the complete bundle of common services easements include all possible common services easements.

As a result of the complete bundle of common services easements granted to the access entity AE, no person or entity other than the access entity AE has the right to provide common services to any location within the developed community DC or to permit access therefor. Such bundled common services easements are created in one of at least two possible ways. First, in a specific embodiment, the bundled common services easements comprise an in gross easement and specific area easements from the development entity D1 to the access entity. The in gross easement, in a specific embodiment, provides the access entity AE the exclusive and perpetual right, privilege and easement over the entire parcel to be developed, for the purpose of providing, identifying and/or contracting with all common services providers FM3, FM4, FM5, FM6 to serve the developed community DC in general as a whole. This in gross easement divests the owner of a lot L of the right to grant any access to such lot L or any neighboring lot to a common services provider not having access rights granted by the access entity. This is so even if the lot owner's lot L is at the boundary between the developed community and real estate not within the developed community. However, even though access to the parcel, and, as a result, to each lot L within the developed community, is so limited by such an in gross easement, no owner is divested of any other easement granting rights, such as mining or drilling rights. The development entity D1 then grants to the access entity AE the right to place facilities and/or infrastructure only within specific easement areas within the parcel. In other specific embodiments, the specific easement areas of the parcel wherein facilities and infrastructure are permitted to be placed include the dedicated roadways to be located within the parcel, whether private or public. In other specific embodiments, the specific easement areas within the parcel include the common areas within the developed community DC. In yet other specific embodiments, the specific easement areas include platted easement areas within each lot L owned by a subscriber S within the developed community DC. In yet other specific embodiments, the complete bundle of common services easements granted to the access entity AE through the in gross easement and specific area easements are set forth in a document executed by the development entity D1 for establishing the common services easements and restrictions K3. The development entity D1 records the grant of bundled easements to the access entity in the appropriate recorder's office in order to ensure that the easements and restrictions granted to the access entity AE are of record and appear within the chain of title, preceded only by the deeds by which the developer D0 or development entity D1 acquired title to the parcel of real property.

Second, in a specific embodiment, the bundled common services easements are created when the development entity D1 grants to the access entity AE specific area easements to place facilities and/or infrastructure only within specific easement areas within the parcel. The development entity D1 then prepares and records declarations, covenants, and restrictions K6 that include restrictions of the right of any person or entity owning a lot L to identify and/or contract with any common services provider to provide common services to such lot L through any area not included in the specific easement areas. In other specific embodiments, the specific area easements are set forth in the common services easements and restrictions document K3. The development entity D1 promptly records the grant of the specific area easements in the appropriate recorder's office in order to ensure that the bundled easements granted to the access entity AE are of record and appear within the chain of title such that the declarations, covenants and restrictions K6 govern and encumber the lots L subject to the previously granted bundled easements.

Referring now to FIG. 2, the access entity AE identifies a third party coordinator FM2 to provide or coordinate the provision of the common services to the developed community DC. In a specific embodiment, a licence K4 is granted from the access entity to the coordinator to permit the coordinator FM2 to provide common services to subscribers S within the community by using the bundled easements. In other specific embodiments, the license K4 permits the coordinator FM2 to sub-license K5 its rights under the license from the access entity to multiple common services providers FM3-FM6. The access entity AE owns the infrastructure, such as plastic, aluminum, fiber glass or other suitable conduit, for housing the medium used to deliver the common services to individual subscribers S. The coordinator FM2 provides or coordinates the provision of the common services through such infrastructure and grants each of the services providers FM3-FM6 a sub-license to use its conduits. The medium through which the coordinator provides or coordinates the provision of telecommunication services is coaxial cable or fiber optic cable or other suitable cables. The coordinator FM2 or the common services providers FM3-FM6 may own the medium placed within the conduit owned by the access entity AE. In a specific embodiment, the coordinator FM2 coordinates provision of particular telecommunication services through sub-licenses for access to provide each such service to individual telecommunication services providers. In other specific embodiments, the sub-licenses additionally grant to the telecommunications services providers FM3-FM6 the right to use the medium owned by the coordinator FM2. In yet other specific embodiments, the coordinator FM2 coordinates the provision of specific deregulated utility services U1-U4 to the subscribers.

FIG. 2 diagrammatically illustrates the embodiment of the new and improved development process of the invention in which the coordinator FM2 makes contractual arrangements K8 with the subscribers S, issues a single bill for all of the common services subscribed to each of the subscribers S. In another embodiment, the subscriber contracts K8 are provided in plurality and extend between each of the subscribers S and the service providers FM3-FM6, individually. In this embodiment, each of the service providers FM3-FM6 bills each of the subscribers S for the common services rendered to the subscriber S.

In a specific embodiment, the development entity D1 prepares and records certain declarations, covenants and restrictions K6 that govern the general use and enjoyment of the developed community DC as a whole as well as individual lots L sold to members of the developed community who will be the subscribers S of the common services. The subscribers S, in other specific embodiments, additionally are members of a homeowner's association HOA formed in connection with a residential developed community DC. The declarations, covenants, and restrictions K6 additionally set forth the arrangement entered into between the access entity AE and the coordinator FM2 for the provision of common services to subscribers S within the developed community DC. In a specific embodiment, the developer D0 or the development entity D1 markets and promotes the developed community DC to prospective lot owners as one having common services coordinated in accordance with any of the specific embodiments described herein. In yet other specific embodiments, the coordinator FM2 or its parent company FM1 under a contract K9 engages in training and assisting the developer D0 or the development entity D1 in marketing the development community DC and the individual lots L contained therein for a fee.

Subsequent to the preparation and recording of the declarations, covenants, and restrictions K6, the developer D0 or the development entity D1 records with the appropriate recording office the plat K7 for the developed community DC. The plat K7 illustrates certain details of the developed community, including drawings of the individual lots L within the parcel, common areas, platted easement areas, roadways, curbs, sidewalks, private drives, and public drives. In a specific embodiment, the plat K7 indicates the locations of the specific area easements granted to the access entity AE. In other specific embodiments, the specific area easements are located within the common areas, roadways, curbs, sidewalks, and/or platted easement areas. In yet other specific embodiments, the locations of the bundled easements are within the roadways, pedestrian through-ways, and private drives throughout the community DC. In other specific embodiments, the plat K7 additionally contains an express dedication to the local municipality M in which the parcel is located, for establishing the public rights-of-way for the roads, curbs, and sidewalks, which public rights-of-way are expressly limited to these particular purposes. The plat K7 additionally illustrates and indicates the locations of such rights-of-way. In all specific embodiments, the dedication of the right-of-way to the municipality M is subject to and limited by the private bundled easements granted to the access entity AE, such that the bundled easements, whether below the surface of the dedicated rights-of-way or otherwise, are not available for access, use or exploitation by the municipality M or other public or semi-public entity or their services provider franchisees.

To complete the development of the community DC, the developer D0 or the development entity D1 contracts with a builder or other contractor for the construction and build-out of the community, including roads, common area infrastructure, and structures on the individual lots L within the parcel, such as homes or office buildings. In a specific embodiment, the builder or developer D0 has an ownership interest in the access entity AE. In another specific embodiment, the ownership interest in all common areas are owned by the homeowners association HOA.

In a specific embodiment, the new and improved process for developing real property of the present invention is carried out through an organized and documented series of contracts between the various entities involved in the process. Referring now to FIGS. 2 and 3, a private parent entity FM1 and/or the coordinator FM2 enters into a development and services agreement K1 with the developer D0 and the access entity AE. The development and services agreement K1 establishes the intent of the parent FM1 and developer D0 to develop a community DC that has bundled common services provided or coordinated through a coordinator FM2. In a specific embodiment, the bundled common services are bundled telecommunication services. In yet another specific embodiment, the common services include basic utility services and other common services desired by the subscribers S.

The development and services agreement K1 further establishes implementation procedures for organizing and providing bundled common services to the developed community DC. In a specific embodiment, the procedures include the formation of the access entity AE by the developer D0 or its development entity D1. In other specific embodiments, the procedures include granting bundled common services easements to the access entity AE. In yet other specific embodiments, the procedures include licensing the bundled common services easements from the access entity AE to the coordinator FM2. In yet other specific embodiments, the procedures include preparing and recording declarations K6 containing provisions regarding the development of a community that provides coordinated common services. In yet other specific embodiments, the procedures include recording a proposed plat K7 for the developed community DC for dedicating the public rights-of-way after and subject to the private bundled easements owned by the access entity AE.

The private parent FM1 entity additionally enters into an access fee agreement K2 through which the parent entity agrees to pay a fee to the developer D0 or development entity D1 and/or the access entity AE after it is formed in exchange for the right to manage the coordination of common services to be provided to the developed community DC. In a specific embodiment, the fee required by the access fee agreement K2 is calculated as a proportional rate of aggregate amounts generated from the provision of bundled common services. In other specific embodiments, the access fee agreement K2 contains a provision for a minimum fee when the rated fee falls below an identified amount. In yet other specific embodiments, the access fee agreement K2 contains provisions that give the parent entity FM1 and/or the coordinator FM2 a most-favored-nations status. This status means that the access entity AE may not license use of the bundled common services easements within the developed community DC to any other entity besides the parent entity FM1 or the coordinator FM2 except upon terms and conditions of use at least as or more favorable to the access entity AE. In a specific embodiment, such equal or more favorable terms and conditions of use provide that such other entity shall provide or coordinate the provision of common services at the same or greater quality than is being offered by the parent entity FM1 and coordinator FM2. In other specific embodiments, such equal or more favorable terms and conditions of use provide that such other entity shall pay a fee equal to or greater than that being paid by parent entity FM1 or coordinator FM2 to the access entity AE for such use of the bundled easements. In yet other specific embodiments, other terms and conditions of use may be alternatively specified in the access fee agreement K2 as directly relevant to maintaining the most-favored-nations status. No such most-favored-nation status is granted to the service providers FM3-FM6 by either coordinator FM2 or access entity AE.

In a specific embodiment, the access fee agreement K2 requires the coordinator FM2 to provide the common services using advanced telecommunications capabilities. Advanced telecommunications capability as used herein refers to a means to provide high speed, broad band telecommunications services that enable subscribers S of such telecommunications services to originate and receive high quality voice, data, graphics, and video telecommunication, over lines, cables, or wireless channels having information-carrying-capability in excess of 200 kilobits per second per subscriber in both directions simultaneously. In other specific embodiments, the access fee agreement K2 requires the coordinator FM2 to provide advanced bundled telecommunications services. Advanced bundled telecommunications services as used herein refers to a means to provide telephone services (local and long distance) CS3, cable television services CS1, internet access services CS2, community intranet services CS2, video-on-demand services CS4, and security monitoring services CSS that are provided using advanced telecommunications capabilities. In yet other specific embodiments, the advanced bundled services require provision of such telecommunications services using premium advanced telecommunication capabilities. Premium advanced telecommunication capability is used herein to refer to advanced telecommunication capability that requires information-carrying-capability in excess of 600 kilobits per second per subscriber in both directions simultaneously. In yet other specific embodiments, advanced bundled services includes single bill billing for all of the services provided thereby.

For the provision of bundled common services to a developed community DC pursuant to the specific embodiment shown in FIG. 2, the coordinator FM2 sublicenses K5 the right to use the bundled common services easements, which are granted by a license from the access entity AE, to various other and individual common services providers FM3-FM6. In a specific embodiment, one or more of the individual common services providers FM3-FM6 are wholly owned subsidiaries of the parent entity FM1 and/or the coordinator FM2. In other specific embodiments, the individual common services providers include an internet service provider/intranet service provider FM3, a cable television services provider FM4, a video-on-demand services provider FM5, a security monitoring services provider FM6.

In a specific embodiment, the coordinator FM2 or the access entity AE places a medium for providing telecommunications services within an infrastructure put in place by the access entity AE or the parent entity FM1 for the provision of telecommunications services. In other specific embodiments, the services medium is a co-axial cable or a fiber optic cable. The individual common services providers license from the coordinator FM2 the use of the services medium that is placed in the access entity's infrastructure. In a specific embodiment, this license K5 is executed and permitted pursuant to a license agreement K4 between the access entity AE and the coordinator FM2 for use of the bundled common services easements.

Referring now to FIG. 4, in a specific embodiment, the coordinator FM2 receives multiple common services from individual common services providers, and then delivers the common services to the subscribers S within the community DC pursuant to individual subscription agreements K8. In this way, the coordinator may invoice individual subscribers S using a single billing statement for all of the common services provided. The fees generated from such single billing may then be allocated by the coordinator FM2 among the individual common services providers FM3-FM6 and its parent company FM1 pursuant to the terms of the particular licensing K4 or sub-licensing K5 arrangement established between the coordinator and each individual common services provider. In other specific embodiments, the coordinator FM2 additionally allocates portions of the fees generated from individual subscribers S within the community DC to account for the fees required to be paid pursuant to be paid to the access fee agreement K2.

In order to maximize the benefit of the arrangements for providing bundled common services to a developed community DC though the efforts of the parent entity FM1 and the coordinator FM2, the order disclosed herein in which particular instruments affecting title and access to the parcel are granted is necessary to prevent those service providers which have franchise arrangements with the particular municipality M (or other public entities which control use of public rights-of-way) in which the community is located from providing common services to the community by accessing, using, or otherwise exploiting the public right-of-way. The bundled common services easements, in which are included all right, title and interest in, to, and related to access throughout the parcel for providing common services, must first be granted to the access entity AE. Subsequently, the public right-of-way is dedicated to and taken by the public or a particular municipality M pursuant to the dedication on the plat K7. In this way, the public right-of-way becomes subject to the private and exclusive bundled easements previously granted to the access entity AE. Referring now to FIG. 1, in a specific embodiment, the common services easements and restrictions document K3, which transfers to the access entity AE the exclusive and perpetual right, privilege and easement throughout the entire developed community DC for the purpose of providing the common services, including identifying and contracting with individual common services providers and placing facilities and infrastructure for the provision of the common services, is executed and recorded after the developer D0 or development entity D1 has obtained its fee simple in the parcel. Once these rights have been granted to the access entity AE and recorded, the developer D0 or development entity D1 may prepared and record the plat K7 for the community DC in which the municipal right-of-way is dedicated and specifically and expressly limited to surface easements related to the roadways, curbs, sidewalks, etc. In other specific embodiments, the plat K7 containing the public right-of-way dedication is not filed and recorded with the appropriate recorder's office until after the access entity AE has arranged to have the common services provided, through the coordinator FM2 or otherwise, including use of license agreements K4 and/or various sub-license agreements K5, if any. In yet other specific embodiments, the plat K7 is additionally not filed and recorded until after the declarations, covenants and restrictions K6 for the developed community DC have been executed and/or filed.

Still referring to FIG. 4, in a specific embodiment, the coordinator FM2 coordinates the provision of telecommunication services through a single service medium. In other specific embodiments, the coordinator FM2 sub-licenses use of the bundled easements for the provision of deregulated common utility services, such as gas U1, water U2, sewer U3, or electricity U4, to the extent that such utility services U1-U4 are available on a deregulated basis, to individual common utility service providers. In yet other specific embodiments, the coordinator FM2 arranges with individual common services providers, with whom it sub-licenses K5 the use of the bundled easements or licenses its services medium, to provide subscribers S within the community DC with a single billing statement for all common services provided to such subscriber. In other specific embodiments, the coordinator FM2 sub-licenses K5 its right to use the bundled common service easements owned by the access entity AE to individual common services providers such that subscribers S of the common services must subscribe K8 to such services individually rather than as a bundle.

In consideration of the proportioned fee it receives from the service coordinator FM2, the parent entity FM1 provides marketing services to the developer D0 or the development entity D1. These marketing services in a specific embodiment, would include developing a market plan for selling portions of the real estate and individual lots by the developer D0 or the development entity D1. In a specific embodiment these marketing services would include training personnel of the developer D0 or the developing entity D1 to sell individual lots for prospective lot owners or subscribers S.

The following example illustrates a specific embodiment of the present invention.

### EXAMPLE 1

In a residential development, two distinct corporate groups may be identified. The first corporate group may be referred to as the “Provider Group”. The Provider Group comprises the Parent, the Coordinator, the Phone Servicer, the Cable Servicer, and the Internet Servicer. All of the entities comprising the Provider Group are incorporated or organized under the laws of a particular state. Phone Servicer is the telephone services provider, providing both local (including call waiting, caller ID, etc.) and long distance services. Phone Servicer provides telephone services within the development over fiberoptic and coaxial cable (collectively, the “Cable”). Outside the development, the Phone Servicer's telephone services are provided through leased fiberoptic facilities connected to the outside world. The Cable within each community is owned by Phone Servicer, and is placed within conduit laid throughout the development. Cable Servicer is the cable provider. Bandwidth over the Cable located within the development and owned by Phone Servicer is leased by Cable Servicer. Internet Servicer is the Internet service provider. Internet Servicer also provides the local neighborhood intranet for the individual communities it serves. The Internet Servicer's intranet provides neighborhood and local content to residences and businesses situated within a particular subdivision, and is a closed network. Except for the homeowners and commercial establishments within the development, third parties are generally denied access to the intranet.

The second distinct corporate group may be referred to as the “Developer Group”. The Developer Group comprises the Developer, which is the entity developing the real estate, and the Access Entity. The Access Entity is created to control the access to the common services easements throughout the development by virtue of having been granted an in gross easement over the entire development for the provision of common services, and a common services area easement designating specific areas where the Access Entity can access each lot for providing the common services. The Developer Group, the homeowners association for the development, third parties, or any combination thereof may have an ownership in the Access Entity; however, the Provider Group and its affiliates will avoid having any ownership in the Access Entity. A related but not included entity within the Developer Group is the Builder for the development.

The Coordinator and the Builder enter into a Builder Model Technology and Marketing Agreement which affords the Builder certain advantages, including monetary consideration and access to services from the Provider Group for use in model homes in the development. In exchange, the Builder agrees to exclusively market the services of the Provider Group. Additionally, the Coordinator and the Developer enter into a Developer Technology Marketing Agreement, which includes monetary consideration to the Developer together with certain marketing assistance in exchange for exclusively marketing the services of the Provider Group. A significant competitive advantage is achieved by marketing directly to the potential homeowners, who are also the potential subscribers of the services of the Provider Group, at the earliest stage of the home buying process, then continuing with the marketing effort through the entire home buying process. At the point competitive service providers become aware of a new homeowner in the area, the homeowner will have already subscribed to the Provider Group services.

The Developer and the Access Entity enter into the Common Services Easements and Restrictions for the transfer and grant of the in gross easement and the specific area easements. The in gross easement vests the Access Entity with the exclusive and perpetual right, privilege and easement over the entire development for the purposes of identifying and contracting with all common service providers, including telephone and cable providers. The specific area easements include the right to place supporting facilities and infrastructure within certain areas of the development, and specifically beneath roadways and platted easement areas. The Common Services Easements and Restrictions is recorded, and thus appears “of record” within the chain of title for the parcel. The recorded Common Services Easements and Restrictions are proceeded only by the deeds by which the Developer Group acquired its title to the development.

The Coordinator and the Access Entity enter into a Nonexclusive License Agreement granted by the Access Entity to the Coordinator allowing the Coordinator to access the development and provide services, which license is consistent with the terms and conditions of the Common Services Easements and Restrictions. As a result, the Coordinator is granted the right to provide, among other services, telephone, cable, and Internet services.

The Coordinator subsequently enters into Sublicense Agreements with the Phone Servicer, the Cable Servicer, and the Internet Servicer, pursuant to the Nonexclusive License Agreement which contemplates the Sublicense Agreements.

In addition to managing and coordinating the provision of the common services, the Coordinator additionally enters into a Development and Services Agreement with the Developer Group, which agreement sets forth the development procedure for common services throughout the development, the committed systems for the provision of the services, the activation schedules for each of the services, the obligations of the parties, the maintenance and operational responsibilities of each party with regard to the provision of services, and all other items which are pertinent to the provision and sustenance of the committed systems for providing the common services. This Development and Services Agreement ensures service levels and performance standards which are to meet or exceed industry standards, it ensures pricing which meets or exceeds effective tariffs for the geographic area, and it includes details for the arrangement which exceed that which is customarily provided by common service providers in such service provider agreements.

In addition to the specific relationships between the entities within each of the Provider Group and the Developer Group, the Developer Group and the Provider Group additionally enter into an Access Fee Agreement which contains the economics of the transaction between the parties. The Access Fee Agreement provides for an access contribution to be made by the Coordinator as initial consideration for this particular arrangement. The access contribution includes infrastructure and marketing contributions, with the infrastructure consisting primarily of the conduit which will be placed throughout the development. The Cable will run through this conduit. The conduit will be owned by the Access Entity, and its use will be leased by the Coordinator so that Phone Servicer may place the cable therethrough. The Access Fee Agreement also provides for access fees to be paid during the term of the agreement. The fees are a percentage of the contribution revenue derived from the common services provided by the Coordinator to individual subscribers in the development. The common services to be provided include local and long distance telephone services, cable, video-on-demand, security monitoring, e-commerce transaction services, Internet, intranet, and community technology and home transaction services. The Access Fee Agreement additionally contains a most favored nations clause which provides that the Developer Group will not extend to any entity access to the common services easements in the development to provide any service provided by the Provider Group under terms or conditions more favorable than those afforded to the Provider Group pursuant to the Access Fee Agreement.

Finally, homeowners within the development subscribe to the various services provided by the Coordinator through Phone Servicer, Cable Servicer, and Internet Servicer, as well as any other service providers contracted for by the Coordinator. Homeowners pay fees to the various service providers under the Coordinator for the services. The revenues, less certain content costs and related expenses, constitute the contribution revenue, a percentage of which is paid by Parent to the Developer Group as access fees under the Access Fee Agreement.

### EXAMPLE 2

In a mixed-use development for use by industrial or commercial entities, two distinct corporate groups may be identified. The first corporate group may be referred to as the “Provider Group”. The Provider Group comprises the Parent, the Coordinator, the Phone Servicer, the Cable Servicer, and the Internet Servicer. All of the entities comprising the Provider Group are incorporated or organized under the laws of a particular state. Phone Servicer is the telephone services provider, providing both local (including call waiting, caller ID, etc.) and long distance services. Phone Servicer provides telephone services to each facility within the development over fiberoptic and coaxial cable (collectively, the “Cable”). Outside the development, the Phone Servicer's telephone services are provided through leased fiberoptic facilities connected to the outside world. The Cable throughout the development is owned by Phone Servicer, and is placed within conduit laid throughout the development. Cable Servicer is the cable provider. Bandwidth over the Cable located within the development and owned by Phone Servicer is leased by Cable Servicer. Internet Servicer is the Internet service provider. Internet Servicer also provides an intranet for the owners or lessees of the facilities within the development. The Internet Servicer's intranet provides local content to businesses situated within the development, and is a closed network. Except for the facility owners and their lessees, third parties are generally denied access to the intranet.

The second distinct corporate group may be referred to as the “Developer Group”. The Developer Group comprises the Developer, which is the entity developing the real estate, and the Access Entity. The Access Entity is created to control the access to the common services easements throughout the development by virtue of having been granted an in gross easement over the entire development for the provision of common services to facilities therein, and a common services area easement designating specific areas where the Access Entity can access each facility site for providing the common services. The Developer Group, an association of facility occupants, third parties, or any combination thereof may have an ownership in the Access Entity; however, the Provider Group and its affiliates will avoid having any ownership in the Access Entity. A related but not included entity within the Developer Group is the Builder for the development.

The Coordinator and the Builder enter into a Builder Model Technology and Marketing Agreement which affords the Builder certain advantages. In exchange, the Builder agrees to exclusively market the services of the Provider Group to prospective purchasers of facility sites. Additionally, the Coordinator and the Developer enter into a Developer Technology Marketing Agreement, which includes monetary consideration to the Developer together with certain marketing assistance in exchange for exclusively marketing the services of the Provider Group. A significant competitive advantage is achieved by marketing directly to the potential site owners, who are also the potential subscribers of the services of the Provider Group, at the earliest stage of the site buying process, then continuing with the marketing effort through the entire site buying process. At the point competitive service providers become aware of a new homeowner in the area, the site owner will have already subscribed to the Provider Group services.

The Developer and the Access Entity enter into the Common Services Easements and Restrictions for the transfer and grant of the in gross easement and the specific area easements. The in gross easement vests the Access Entity with the exclusive and perpetual right, privilege and easement over the entire development for the purposes of identifying and contracting with all common service providers, including telephone and cable providers. The specific area easement include the right to place supporting facilities and infrastructure within certain areas of the development, and specifically beneath roadways and platted easement areas. The Common Services Easements and Restrictions is recorded, and thus appears “of record” within the chain of title for the parcel. The recorded Common Services Easements and Restrictions are proceeded only by the deeds by which the Developer Group acquired its title to the development.

The Coordinator and the Access Entity enter into a Nonexclusive License Agreement granted by the Access Entity to the Coordinator allowing the Coordinator to access the development and provide services, which license is consistent with the terms and conditions of the Common Services Easements and Restrictions. As a result, the Coordinator is granted the right to provide, among other services, telephone, cable, and Internet services.

The Coordinator subsequently enters into Sublicense Agreements with the Phone Servicer, the Cable Servicer, and the Internet Servicer, pursuant to the Nonexclusive License Agreement which contemplates the Sublicense Agreements.

In addition to managing and coordinating the provision of the common services, the Coordinator additionally enters into a Development and Services Agreement with the Developer Group, which agreement sets forth the development procedure for common services throughout the development, the committed systems for the provision of the services, the activation schedules for each of the services, the obligations of the parties, the maintenance and operational responsibilities of each party with regard to the provision of services, and all other items which are pertinent to the provision and sustenance of the committed systems for providing the common services. This Development and Services Agreement ensures service levels and performance standards which are to meet or exceed industry standards, it ensures pricing which meets or exceeds effective tariffs for the geographic area, and it includes details for the arrangement which exceed that which is customarily provided by common service providers in such service provider agreements.

In addition to the specific relationships between the entities within each of the Provider Group and the Developer Group, the Developer Group and the Provider Group additionally enter into an Access Fee Agreement which contains the economics of the transaction between the parties. The Access Fee Agreement provides for an access contribution to be made by the Coordinator as initial consideration for this particular arrangement. The access contribution includes infrastructure and marketing contributions, with the infrastructure consisting primarily of the conduit which will be placed throughout the development. The Cable will run through this conduit. The conduit will be owned by the Access Entity, and its use will be leased by the Coordinator so that Phone Servicer may place the cable therethrough. The Access Fee Agreement also provides for access fees to be paid during the term of the agreement. The fees are a percentage of the contribution revenue derived from the common services provided by the Coordinator to individual subscribers in the development. The common services to be provided include local and long distance telephone services, cable, security monitoring, e-commerce transaction services, Internet, intranet, and community technology and business-to-business transaction services. The Access Fee Agreement additionally contains a most favored nations clause which provides that the Developer Group will not extend to any entity access to the common services easements in the development to provide any service provided by the Provider Group under terms or conditions more favorable than those afforded to the Provider Group pursuant to the Access Fee Agreement.

Finally, facility occupants within the development subscribe to the various services provided by the Coordinator through Phone Servicer, Cable Servicer, and Internet Servicer, as well as any other service providers contracted for by the Coordinator. The facility occupants pay fees to the various service providers under the Coordinator for the services. The revenues, less certain content costs and related expenses, constitute the contribution revenue, a percentage of which is paid by Parent to the Developer Group as access fees under the Access Fee Agreement.

### EXAMPLE 3

In a multi-family dwelling complex, two distinct corporate groups may be identified. The first corporate group may be referred to as the “Provider Group”.

The Provider Group comprises the Parent, the Coordinator, the Phone Servicer, the Cable Servicer, and the Internet Servicer. All of the entities comprising the Provider Group are incorporated or organized under the laws of a particular state. Phone Servicer is the telephone services provider, providing both local (including call waiting, caller ID, etc.) and long distance services. Phone Servicer provides telephone services to each building within the complex over fiberoptic and coaxial cable (collectively, the “Cable”). Outside the complex, the Phone Servicer's telephone services are provided through leased fiberoptic facilities connected to the outside world. The Cable within the complex is owned by Phone Servicer, and is placed within conduit laid throughout the complex. Cable Servicer is the cable provider. Bandwidth over the Cable located within the complex and owned by Phone Servicer is leased by Cable Servicer. Internet Servicer is the Internet service provider. Internet Servicer also provides the local community intranet for the complex. The Internet Servicer's intranet provides community and local content to residents within the complex, and is a closed network. Except for the residents within the complex, third parties are generally denied access to the intranet.

The second distinct corporate group may be referred to as the “Developer Group”. The Developer Group comprises the Developer, which is the entity developing the real estate, and the Access Entity. The Access Entity is created to control the access to the common services easements throughout the complex by virtue of having been granted an in gross easement over the entire complex for the provision of common services, and a common services area easement designating specific areas where the Access Entity can access each lot for providing the common services. The Developer Group, the renters or unit owners association for the complex, third parties, or any combination thereof may have an ownership in the Access Entity; however, the Provider Group and its affiliates will avoid having any ownership in the Access Entity. A related but not included entity within the Developer Group is the Builder for the complex.

The Coordinator and the Builder enter into a Builder Model Technology and Marketing Agreement which affords the Builder certain advantages, including monetary consideration and access to services from the Provider Group for use in model buildings in the complex. In exchange, the Builder agrees to exclusively market the services of the Provider Group. Additionally, the Coordinator and the Developer enter into a Developer Technology Marketing Agreement, which includes monetary consideration to the Developer together with certain marketing assistance in exchange for exclusively marketing the services of the Provider Group. A significant competitive advantage is achieved by marketing directly to the potential residents, who are also the potential subscribers of the services of the Provider Group, at the earliest stage of the residential searching process, then continuing with the marketing effort through the entire residential searching process. At the point competitive service providers become aware of a new resident in the area, the resident will have already subscribed to the Provider Group services.

The Developer and the Access Entity enter into the Common Services Easements and Restrictions for the transfer and grant of the in gross easement and the specific area easements. The in gross easement vests the Access Entity with the exclusive and perpetual right, privilege and easement over the entire complex for the purposes of identifying and contracting with all common service providers, including telephone and cable providers. The specific area easement include the right to place supporting facilities and infrastructure within certain areas of the complex, and specifically beneath roadways and platted easement areas. The Common Services Easements and Restrictions is recorded, and thus appears “of record” within the chain of title for the parcel. The recorded Common Services Easements and Restrictions are proceeded only by the deeds by which the Developer Group acquired its title to the complex.

The Coordinator and the Access Entity enter into a Nonexclusive License Agreement granted by the Access Entity to the Coordinator allowing the Coordinator to access the complex and provide services, which license is consistent with the terms and conditions of the Common Services Easements and Restrictions. As a result, the Coordinator is granted the right to provide, among other services, telephone, cable, and Internet services.

The Coordinator subsequently enters into Sublicense Agreements with the Phone Servicer, the Cable Servicer, and the Internet Servicer, pursuant to the Nonexclusive License Agreement which contemplates the Sublicense Agreements.

In addition to managing and coordinating the provision of the common services, the Coordinator additionally enters into a Development and Services Agreement with the Developer Group, which agreement sets forth the development procedure for common services throughout the complex, the committed systems for the provision of the services, the activation schedules for each of the services, the obligations of the parties, the maintenance and operational responsibilities of each party with regard to the provision of services, and all other items which are pertinent to the provision and sustenance of the committed systems for providing the common services. This Development and Services Agreement ensures service levels and performance standards which are to meet or exceed industry standards, it ensures pricing which meets or exceeds effective tariffs for the geographic area, and it includes details for the arrangement which exceed that which is customarily provided by common service providers in such service provider agreements.

In addition to the specific relationships between the entities within each of the Provider Group and the Developer Group, the Developer Group and the Provider Group additionally enter into an Access Fee Agreement which contains the economics of the transaction between the parties. The Access Fee Agreement provides for an access contribution to be made by the Coordinator as initial consideration for this particular arrangement. The access contribution includes infrastructure and marketing contributions, with the infrastructure consisting primarily of the conduit which will be placed throughout the complex. The Cable will run through this conduit. The conduit will be owned by the Access Entity, and its use will be leased by the Coordinator so that Phone Servicer may place the cable therethrough. The Access Fee Agreement also provides for access fees to be paid during the term of the agreement. The fees are a percentage of the contribution revenue derived from the common services provided by the Coordinator to individual subscribers in the complex. The common services to be provided include local and long distance telephone services, cable, video-on-demand, security monitoring, e-commerce transaction services, Internet, intranet, and community technology and home transaction services. The Access Fee Agreement additionally contains a most favored nations clause which provides that the Developer Group will not extend to any entity access to the common services easements in the complex to provide any service provided by the Provider Group under terms or conditions more favorable than those afforded to the Provider Group pursuant to the Access Fee Agreement.

Finally, residents within the complex subscribe to the various services provided by the Coordinator through Phone Servicer, Cable Servicer, and Internet Servicer, as well as any other service providers contracted for by the Coordinator. Residents pay fees to the various service providers under the Coordinator for the services. The revenues, less certain content costs and related expenses, constitute the contribution revenue, a percentage of which is paid by Parent to the Developer Group as access fees under the Access Fee Agreement.

The new and improved process for development of real property of the invention takes advantage of the current scheme of federal deregulation of common services providers in order to provide consumers with more choices for obtaining such services. The new and improved process additionally separates private easements for the provision of common services in a developed community from the public right-of-way. The new and improved process also establishes control over and access to private easements in a developed community for the provision of common services in one private decision-making entity that identifies and contracts with several service providers. The new and improved process for development of a parcel of real property also precludes access, use, and exploitation of the public right-of-way dedicated within a developed community by municipal franchisee service providers. The new and improved process allows for the provision or management of telecommunication services to individual subscribers in a developed community by a single service provider. The new and improved process also anticipates and encourages the provision of telecommunication services to subscribers in a developed community in a way that does not clutter or slow down the telecommunication service medium and access points for individual subscribers. The new and improved process allows for a single provider of telecommunication services to provide such services to a developed community through one medium or only a few media that require access points to each subscriber. Finally, the new and improved process includes all of these features, and is relatively simple to implement.

While a specific embodiment of the invention has been shown and described herein for purposes of illustration, the protection afforded by any patent which may issue upon this application is not strictly limited to the disclosed embodiment; but rather extends to all structures and arrangements which fall fairly within the scope of the claims which are appended hereto:

What is claimed is:

1. A process for developing real estate, comprising the steps of: separating private easements for the provision of common services in a developed community from dedicated public rights-of-way; establishing decision making authority regarding control over said private easements in a privately owned entity to identify and contract with various service providers; precluding access to said private easements by governmental franchisees for providing common services; and providing common services to said developed community through a single source, said single source obtaining common services from one or more common services providers.

2. A process by a developer entity for establishing in a privately owned access entity the beneficial and exclusive ownership of and control over access to common services easements within a developed community, comprising the steps of: acquiring fee simple ownership in a parcel of real estate for developing into a community; transferring exclusive rights in and to common services easements within said parcel to said access entity; and dedicating public rights-of-way for roadways, curbs, and sidewalks to a municipality, said dedicated public rights-of-way being taken by said municipality subject to said exclusive rights, whereby said municipality has no control over common services access as a result of said dedicated public rights-of-way, and whereby common services providers having acquired rights through said municipality have no access to said community through said dedicated public rights-of-way.

3. The process of claim 2 wherein said exclusive rights comprise an in gross easement and specific area easements.

4. The process of claim 2 wherein said exclusive rights comprise specific area easements, and wherein any other easements for providing common services within said developed community are restricted by declarations, covenants and restrictions governing and running with said parcel of real estate.

5. The process of claim 2 wherein said developer entity and said access entity are separate entities.

6. The process of claim 2 wherein said exclusive rights transferred by developer entity to said access entity include the right to establish infrastructure for common services on both commonly owned and privately owned areas within said community.

7. The process of claim 2 wherein said exclusive rights transferred by developer entity to said access entity include the rights to contract with providers of common services for providing services to said community.

8. The process of claim 2 further comprising the step of recording said transferring of said exclusive rights with an appropriate governmental real estate records office, whereby said common services easements appear within the chain of title of said parcel before said dedication of said public rights-of-way.

9. The process of claim 2 wherein said common services comprise one or more services selected from the group of services consisting of: cable services, internet services, intranet services, local telephone services, long distance telephone services, video-on-demand services, and security monitoring services.

10. The process of claim 2 wherein said common services comprise one or more services selected from a group of deregulated utility services consisting of: sewer services, water services, gas services, and electricity services.

11. The process of claim 2 wherein each step is performed pursuant to obligations arising out of a system of interrelated contractual requirements regarding the development of said community.

12. A process for obtaining a license for access to private common services easements on a parcel of real estate, which comprises the steps of: assisting a real estate developer in establishing private ownership and control of common services easements within said parcel of real estate to be developed into a community; and implementing a fee structure that encourages the owner of said private common services easements to enter into and maintain license arrangements that permit at least one licensee to utilize said private common services easements for providing common services to said community; said fee structure providing a competitive shield for establishing said licensees as single sources of common services for said community.

13. The process of claim 12 wherein said owner of said private common services easements is a private access entity.

14. The process of claim 13 wherein said establishing step comprises the steps of: acquiring fee simple ownership in a parcel of real estate for developing into a community; transferring exclusive rights of common services easements in said parcel to said access entity; and dedicating public rights-of-way for roadways, curbs, and sidewalks to a municipality, said dedicated public rights-of-way being taken by said municipality subject to said exclusive rights, whereby said municipality has no control over common services access as a result of said dedicated public rights-of-way, and whereby common services providers having acquired rights through said municipality have no access to said community through said dedicated public rights-of-way.

15. The process of claim 14 wherein said common services comprise advanced bundled services.

16. The process of claim 14 wherein said common services comprise premium advanced bundled services.

17. The process of claim 14 wherein said competitive shield comprises minimum access fee amounts and most favored nations status whereby said private access entity may grant licenses to other common service providers in the event said fee structure is equaled or bettered by any other common service provider.

18. The process of claim 17 wherein said competitive shield additionally comprises a reduction in said access fee amounts when said common services comprise advanced bundled services, said reduction being relative to aggregate amounts of individualized access fees for individual services included in said common services.

19. The process of claim 14 wherein said license permits said licensee to sublicense use of said private easements to individual providers of services included in said common services.

20. A process for providing common services to a developed community through a single source provider, which comprises the steps of: entering into a license arrangement with an access entity that owns and controls common services easements on a parcel of real estate to be developed as a community, said license arrangement permitting access to and utilization of said easements; and utilizing said easements for providing common services to said community; wherein owners of lots within said community contract with said single source provider for the provision or coordination of said common services.

21. The process of claim 20 wherein said access entity has beneficial and exclusive ownership of and control over all access to said common services easements within said developed community.

22. The process of claim 21 wherein said beneficial and exclusive ownership of and control over said access is created by a process which comprises the steps of: acquiring fee simple ownership in a parcel of real estate for developing into a community; transferring exclusive rights of common services easements in said parcel to said access entity; and dedicating public rights-of-way on said parcel for roadways, curbs, and sidewalks to a municipality, said dedicated public rights-of-way being taken by said municipality subject to said exclusive rights, whereby said municipality has no control over common services access as a result of said dedicated public rights-of-way, and whereby common services providers having acquired rights through said municipality have no access to said community through said dedicated public rights-of-way.

23. The process of claim 20 wherein said common services are provided to a plurality of lots in said community over fewer than three cables.

24. The process of claim 23 wherein said cables are of a type selected from the group of cables consisting of co-axial and fiber optic cables.

25. The process of claim 20 wherein said license arrangement permits said single source provider to sublicense utilization of said easements to a plurality of individual providers of services included in said common services.

26. The process of claim 25 wherein at least one of said individual service providers is a wholly owned subsidiary of said single source.

27. The process of claim 25 wherein said individual providers provide said common services to said single source at a central receiving facility wherefrom said single source distributes said common services to a plurality of lots in said community.

28. The process of claim 20 wherein said common services comprise one or more services selected from the following group of services consisting of: cable services, internet services, intranet services, local telephone services, long distance telephone services, video-on-demand services, and security monitoring services.

29. The process of claim 20 wherein said common services comprise one or more services selected from a group of deregulated utility services consisting of: sewer services, water services, gas services, and electricity services.

30. The process of claim 20 wherein said common services comprise advanced bundled services.

31. The process of claim 20 wherein said common services comprise premium advanced bundled services.

32. The process of claim 20 wherein said license arrangement is entered into pursuant to obligations arising out of a system of interrelated contractual requirements regarding the development of said community.

33. A method of separating real estate easements from land ownership comprising the steps of: acquiring fee simple title in a parcel of real estate by a developer; separating in gross common services easements from said fee simple title; separating the public right-of-way from said common services easements and said fee simple title; separating all other easements from said common services easements and from said public right-of-way and from said fee simple title; licensing at least one of said all other easements to a privately owned company for a fee; and dedicating said public right-of-way to the public; whereby said public right-of-way is dedicated subject to said transferred easements to said privately owned company thereby eliminating public control over said licensed easements and all rights to access to said parcel for providing common services.

34. The method of claim 33 wherein said steps further comprise said privately owned company constructing utility conduits on said parcel in accordance with said easements licensed to said company, said privately owned company sublicensing service providers for a fee to provide common services to owners of any portion of said parcel, and said privately owned company allowing said sub-licensed common services providers to use said conduits.

35. The method of claim 33 wherein said common services providers provide one or more common services to owners of portions of said parcel selected from the group of services consisting of cable services, internet services, intranet services, local telephone services, long distance telephone services, video-on-demand services and security monitoring services.

36. The method of claim 33 wherein said common services providers provide one or more common services to owners of portions of said parcel selected from the group of deregulated utility services consisting of sewer services, water services, gas services, and electricity services.

37. The method of claim 33 wherein said fee is proportioned and passed on to said private company by said service providers.

38. The method of claim 37 wherein said fee is proportioned and passed on to the owner of said privately owned company.

39. The method of claim 38 further comprising the steps of said owner of said privately owned company developing a market plan for selling portions of said parcel by a developer, and said owner engaging in the training of said developer in marketing portions of said parcel.

40. The method of claim 39 further comprising the steps of said developer contracting the construction of roads, other common infrastructure, homes on individual portions of said parcel, and the construction on said parcel and the development of said parcel.

41. The method of claim 34 wherein said privately owned company manages all of said sub-licensed service providers.
